(19) United States
(12) Patent Application Publication
(10) Pub. No.: US 2020/0395607 A1
(43) Pub. Date: Dec. 17, 2020

(54) Composite electrode material, method for manufacturing the same, composite electrode comprising the same and lithium-based battery comprising the said composite electrode

(71) Applicant: National Cheng Kung University, Tainan City (TW)

(72) Inventor: Yon-Hua TZENG, Tainan City (TW)

(73) Assignee: NATIONAL CHENG KUNG UNIVERSITY

(21) Appl. No.: 16/813,975

(22) Filed: Mar. 10, 2020

Related U.S. Application Data
(60) Provisional application No. 62/860,342, filed on Jun. 12, 2019.

(51) Int. Cl. H01M 4/36; H01M 10/0525; H01M 4/38; H01M 4/62; H01M 4/48

(52) U.S. Cl. CPC H01M 4/366; H01M 10/0525; H01M 2004/021; H01M 4/625; H01M 4/483; H01M 4/386

(57) ABSTRACT

A composite electrode material, a method for manufacturing the same, a composite electrode comprising the same and a lithium-based battery comprising the said composite electrode are disclosed. The composite electrode material comprises: a core, wherein a material of the core is at least one selected from the group consisting of Si, Ge, and a partially oxidized compound thereof; and an oxidized layer encapsulating at least a portion of a surface of the core, wherein a material of the oxidized layer is a fully oxidized compound of Si, a fully oxidized compound of Ge or a combination thereof, wherein the material in a portion of the core reacts with lithium ions for lithiation and de-lithiation.

### CROSS REFERENCE TO RELATED APPLICATION

This application claims the benefit of filing date of U.S. Provisional Application Ser. No. 62/860,342, entitled “COMPOSITE ELECTRODE MATERIAL AND METHOD FOR MANUFACTURING THE SAME, COMPOSITE ELECTRODE CONTAINING SAID COMPOSITE ELECTRODE MATERIAL, AND LI-BASED BATTERY COMPRISING SAID COMPOSITE ELECTRODE” filed Jun. 12, 2019 under 35 USC § 119(e)(1).

### BACKGROUND

### 1. Field

The present disclosure relates to a composite electrode material, a method for manufacturing the same, a composite electrode comprising the same and a lithium-based battery comprising the said composite electrode.

### 2. Description of Related Art

Lithium ion battery is nowadays considered as one of the most efficient ways to store energy due to its high working voltage, high energy density, high battery power, and long lifespan of storage. At present, graphite is a common commercial material for negative electrode of Li-ion battery, and the theoretical capacity value is about 372 mAhg⁻¹. However, a solid electrolyte interphase (SEI) formed after the first charge often results in an irreversible capacity loss. Hence, the real capacity value is lower than the theoretical value. However, the need of capacity value grows with the advance of science and technology, and simple graphite electrode is unable to meet the needs of the public nowadays.

Currently, researchers tend to study non-carbon materials regarding negative electrode materials, such as Al, Mg, Sb, Sn, Ge, Si, and so on. Among them, silicon has drawn lots of attention since it has a theoretical capacity value of up to 4200 mAhg⁻¹. However, the volume of silicon changes by about up to 420% during charge/discharge process, which is much higher than that of carbon (12%). Therefore, it is likely to cause pulverization of silicon, and thus the pulverized silicon particles losses conductive contact among themselves. Thereby, lithium ions cannot be successfully stored and released, and thus the capacity will decrease. At the same time, newly exposed surfaces of the pulverized silicon particles will consume the electrolyte and react with it to form new SEI. After repeated charge/discharge, the electrolyte is continuously consumed and then depleted by generating new SEI, resulting in a shortened battery lifespan.

Therefore, there is a need to develop a composite electrode material, which has a high charge storage capacity and can overcome the downsides caused by repeated charge/discharge, to obtain higher battery efficiency than that of a Li-based battery with graphite electrodes.

### SUMMARY

An object of the present disclosure is to provide a novel composite electrode material, a method for manufacturing the same, a composite electrode comprising the same and a lithium-based battery comprising the said composite electrode.

The composite electrode material of the present disclosure comprises: a core, wherein a material of the core is at least one selected from the group consisting of Si, Ge, and a partially oxidized compound thereof; and an oxidized layer encapsulating at least a portion of a surface of the core, wherein a material of the oxidized layer is a fully oxidized compound of Si, a fully oxidized compound of Ge or a combination thereof, wherein the material in a portion of the core reacts with lithium ions for lithiation and de-lithiation.

In addition, the method for manufacturing the aforesaid composite electrode material of the present disclosure comprises the following steps: providing a mother core, wherein a material of the mother core is at least one selected from the group consisting of Si and Ge; oxidizing the mother core to form a mother oxidized layer on a surface of the mother core, wherein a material of the mother oxidized layer is a fully oxidized compound of Si, a fully oxidized compound of Ge or a combination thereof; and breaking the mother core with the mother oxidized layer formed thereon to obtain a composite electrode material, which comprises: a core derived from the mother core; and an oxidized layer derived from the mother oxidized layer, wherein the oxidized layer partially exposes the core, and a material of the core exposed from the oxidized layer reacts with lithium ions for lithiation and de-lithiation.

In the method of the present disclosure, the mother core is oxidized to fabricate a mother oxidized layer as a capsule which holds the core together and provides chemically stable surfaces.

In one embodiment of the present disclosure, the material of the mother core comprises silicon. In another embodiment of the present disclosure, the material of the mother core comprises partially oxidized silicon (SiOₓ, x<2). In further another embodiment of the present disclosure, the material of the mother core comprises both silicon and partially oxidized silicon. The mother core comprising silicon, partially oxidized silicon or both is oxidized to provide a layer of hard, mechanically strong and chemically inert silicon dioxide to surround the mother core.

Next, the mother core with the mother oxidized layer formed thereon is broken to obtain the composite electrode material of the present disclosure. The mother core with the mother oxidized layer formed thereon is broken into two or multiple pieces to expose a portion of a surface of the core along a breaking line. Thus, in the obtained composite electrode material of the present disclosure, the oxidized layer encapsulates at least a portion of the core. For example, one or multiple regions of the surface of the core are not covered by the oxidized layer. Herein, the core partially exposed from the oxidized layer and without being covered by the oxidized layer can react with lithium for lithiation and de-lithiation.

In one embodiment of the present disclosure, the material of the core comprises silicon, and the oxidized layer is a silicon dioxide layer. In another embodiment of the present disclosure, the material of the core comprises partially oxidized silicon (SiOₓ, x<2), and the oxidized layer is a silicon dioxide layer. In further another embodiment of the present disclosure, the material of the core comprises both silicon and partially oxidized silicon, and the oxidized layer is a silicon dioxide layer. Herein, the silicon dioxide layer encapsulated core comprising silicon, partially oxidized silicon or both is broken into two or more pieces to expose a portion of the surface of the core for lithiation and de-lithiation. The material of the core provides high charge storage capacity while the silicon dioxide layer prevents the core from becoming a loose cluster of small particles after repetitive expansion and shrinkage in volume during charging and discharging cycles.

After breaking the mother core with the mother oxidized layer formed thereon, a broken mother core with a broken mother oxidized layer can be directly used as a composite electrode material of the present disclosure, wherein the broken mother core is functioned as the core of the composite electrode material, and the broken mother oxidized layer is functioned as the oxidized layer of the composite electrode material.

In another embodiment of the present disclosure, the method of the present disclosure may further comprise a step of: oxidizing the broken mother core to form a thin oxidized layer on a surface of the broken mother core without being covered by the broken mother oxidized layer after breaking the mother core with the mother oxidized layer formed thereon. Herein, the broken mother core is functioned as the core of the composite electrode material. The broken mother oxidized layer is integrated with the thin oxidized layer, and the broken mother oxidized layer together with the thin oxidized layer is functioned as the oxidized layer of the composite electrode material. In this case, the whole surface of the core of the composite electrode material is encapsulated by the oxidized layer, and a portion of the oxidized layer is very thin. For example, a thickness of the thin oxidized layer can be in a range from 0.1 nm to 1 nm. Because the thin oxidized layer is very thin, the lithium ions still can penetrate through the thin oxidized layer for lithiation and de-lithiation.

In one embodiment of the present disclosure, the material of the core and the mother core is Si to provide a high capacity, and the material of the oxidized layer and the mother oxidized layer is silicon dioxide.

In the present disclosure, the shape of the core is not particularly limited. In one embodiment of the present disclosure, the core is a flake particle or a paper-like thin sheet to improve the capacity and cycle count of the electrode.

In the present disclosure, the thickness of the core is not particularly limited. In one embodiment of the present disclosure, the thickness of the core can be in a range from 50 nm to 500 nm, for example, from 50 nm to 400 nm, from 50 nm to 300 nm, from 50 nm to 200 nm, from 80 nm to 200 nm, or from 80 nm to 120 nm.

In the present disclosure, the length or the width of the core is not particularly limited. In one embodiment of the present disclosure, the length or the width of the core can be in a range from 50 nm to 9 μm, for example, from 100 nm to 9 μm, from 200 nm to 5 μm, from 200 nm to 3 μm, from 300 nm to 3 μm, from 300 nm to 2 μm, from 300 nm to 1500 nm, from 400 nm to 1500 nm, or from 500 nm to 1200 nm.

In the present disclosure, the thickness of the oxidized layer can be in a range from 5 nm to 200 nm, for example, from 5 nm to 150 nm, from 10 nm to 100 nm, from 10 nm to 50 nm, or from 10 nm to 30 nm.

In addition, the method of the present disclosure can further comprise a step of forming a graphitic nanocarbon layer on the oxidized layer after the step of breaking the mother core with the mother oxidized layer formed thereon. Thus, the obtained composite electrode material of the present disclosure may further comprise a graphitic nanocarbon layer, wherein the graphitic nanocarbon layer is formed on the oxidized layer.

Furthermore, the method of the present disclosure can further comprise a step of forming a graphitic nanocarbon layer on the oxidized layer and the core exposed from the oxidized layer after the step of breaking the mother core with the mother oxidized layer formed thereon. Thus, the obtained composite electrode material of the present disclosure may further comprise: a graphitic nanocarbon layer, wherein the graphitic nanocarbon layer is formed on the oxidized layer and on the surface of the core exposed from the oxidized layer.

In the present disclosure, the graphitic nanocarbon layer can be a graphitic thin-film or fiber-shaped nanocarbon layer. For example, the graphitic nanocarbon layer may comprise graphene nanowalls, graphene-like carbon nanowalls, carbon nanotubes, carbon fibers, graphitic particles, a graphitic film or a combination thereof. Herein, the graphene nanowalls, the graphene-like carbon nanowalls, the carbon nanotubes, the carbon fibers, the graphitic particles or the graphitic film may grow upright on the surface of the core or be mixed and in contact with the core, so that it may have multiple and multi-directional conductivity as well as a buffer function for expansion and contraction of the silicon. Furthermore, the graphitic nanocarbon layer may protect the material of the core from overreacting with the electrolyte.

The method for forming the graphitic nanocarbon layer is not particularly limited. In one embodiment of the present disclosure, the graphitic nanocarbon layer is formed by a coating process such as a plasma assisted deposition or thermal chemical vapor deposition. In another embodiment of the present disclosure, the graphitic nanocarbon layer is formed by mixing pre-synthesized graphitic nanocarbons with the core with the oxidized layer formed thereon, and thus the pre-synthesized graphitic nanocarbons is directly in contact with the core with the oxidized layer formed thereon.

The process of the plasma assisted deposition or thermal chemical vapor deposition may comprise a step of stirring the core with a rotary stirring machine or with a rotating holder for the core, so that the graphitic nanocarbons may grow more evenly on the core. Thereby, it may also reduce the time it takes to repeatedly cool and break a vacuum for stirring the core for further growth. Herein, the rate of stirring and rotation is not limited and it may be changed depending on the used stirring machine and the rotation machine as long as the graphitic nanocarbons can grow more evenly on the core. In addition, the conditions of the plasma assisted deposition and thermal chemical vapor deposition are not limited and it may be adjusted in accordance with the desired shape and size of the graphitic nanocarbons.

The plasma assisted deposition capable of using in the present disclosure may be any plasma assisted deposition known in the art, for example, but is not limited to, microwave plasma chemical vapor deposition (microwave plasma CVD), to grow the graphitic nanocarbons on the surfaces of the cores.

In one aspect of the present invention, the microwave plasma chemical vapor deposition and thermal chemical vapor deposition are preferably conducted at 600-1250° C. to grow the graphitic nanocarbons on the surface of a core. The conditions for the microwave plasma CVD and thermal CVD used are commonly known processes. Any person skilled in the art can select proper conditions as needed.

In addition, the present disclosure further provides a composite electrode, which comprises: a substrate; and an active material layer disposed on the substrate and comprising the aforesaid composite electrode material.

In the composite electrode of the present disclosure, the substrate may be a conductive metal plate. Moreover, a material of the conductive metal plate may, by way of example and not limitation, be a copper foil which is commonly used in the art. Furthermore, the thickness of the copper foil may be changed if necessary.

In the composite electrode of the present disclosure, the active material layer may further comprise an adhesive. Herein, the adhesive may, by way of example and not limitation, be sodium carboxymethyl cellulose (NaCMC), poly acrylic acid (PAA), and the like. In one embodiment of the present disclosure, NaCMC is used as an adhesive.

Furthermore, the present disclosure further provides a lithium-based battery, which comprises: the aforesaid composite electrode; a counter electrode opposite to the composite electrode; a separator disposed between the composite electrode and the counter electrode; and an electrolyte layer disposed between the composite electrode and the separator and also disposed between the counter electrode and the separator. Herein, the composite electrode is used as an anode, and the counter electrode is used as a cathode which may comprise lithium.

As described above, the composite electrode material of the present disclosure has a special structure, wherein the material of the core comprises Si, Ge or a partially oxidized compound thereof, and the core is at least partially encapsulating by a fully oxidized compound of Si, a fully oxidized compound of Ge or a combination thereof. In one embodiment of the present disclosure, the material of the core comprises Si or a partially oxidized compound thereof, and the core is at least partially encapsulating by a silicon dioxide layer. In addition, on and surrounding the oxidized layer, the graphitic carbons are grown directly. Alternatively, pre-synthesized graphitic carbons are mixed with the core with the oxidized layer formed thereon. In addition, the graphitic nanocarbons have excellent electrical conductivity, and thus can transport electrons effectively as well as prevent the core from overreacting with the electrolyte. These properties improve the battery cycle life. Therefore, the Li-based battery of the present disclosure has long battery cycle life and high charge storage capacity, and thus has excellent charging/discharging characteristics and Coulombic efficiency after numerous cycles.

Other objects, advantages, and novel features of the invention will become more apparent from the following detailed description when taken in conjunction with the accompanying drawings.

### BRIEF DESCRIPTION OF THE DRAWINGS

FIG. 1A is a cross-sectional view of a mother core with a mother oxidized layer formed thereon in one embodiment of the present disclosure.

FIG. 1B is a cross-sectional view of breaking a mother core with a mother oxidized layer formed thereon into two pieces in one embodiment of the present disclosure.

FIG. 1C is a cross-sectional view of breaking a mother core with a mother oxidized layer formed thereon into three pieces in one embodiment of the present disclosure.

FIG. 1D is a cross-sectional view of a Li-based battery in one embodiment of the present disclosure.

FIG. 2A and FIG. 2B are respectively cross-sectional views of a composite electrode material before and after expanding in one embodiment of the present disclosure.

FIG. 3A and FIG. 3B are respectively cross-sectional views of a composite electrode material before and after expanding in another embodiment of the present disclosure.

FIG. 4A and FIG. 4B are respectively cross-sectional views of a composite electrode material before and after expanding in another embodiment of the present disclosure.

FIG. 5 shows a capacity as a function of charge-discharge cycles of a test cell with an anode made of silicon flakes without encapsulation by silicon dioxide in Comparative example 1 of the present disclosure.

FIG. 6 shows a capacity as a function of charge-discharge cycles of a test cell with an anode made of silicon flakes fully encapsulated by silicon dioxide in Comparative example 2 of the present disclosure.

FIG. 7 shows a capacity as a function of charge-discharge cycles of a test cell with an anode made of silicon flakes partially encapsulated by silicon dioxide in Example 3 of the present disclosure.

FIG. 8 shows a capacity as a function of charge-discharge cycles of a test cell with an anode made of silicon flakes partially encapsulated by silicon dioxide and coated with electrically conductive nanocarbon including carbon nanotubes and carbon fibers in Example 4 of the present disclosure.

### DETAILED DESCRIPTION OF EMBODIMENT

The following embodiments when read with the accompanying drawings are made to clearly exhibit the above-mentioned and other technical contents, features and/or effects of the present disclosure. Through the exposition by means of the specific embodiments, people would further understand the technical means and effects the present disclosure adopts to achieve the above-indicated objectives. Moreover, as the contents disclosed herein should be readily understood and can be implemented by a person skilled in the art, all equivalent changes or modifications which do not depart from the concept of the present disclosure should be encompassed by the appended claims.

Furthermore, the terms recited in the specification and the claims such as “above”, “over”, or “on” are intended not only directly contact with the other element, but also intended indirectly contact with the other element. Similarly, the terms recited in the specification and the claims such as “below”, or “under” are intended not only directly contact with the other element but also intended indirectly contact with the other element.

Furthermore, the terms recited in the specification and the claims such as “connect” is intended not only directly connect with other element, but also intended indirectly connect and electrically connect with other element.

Furthermore, when a value is in a range from a first value to a second value, the value can be the first value, the second value, or another value between the first value and the second value.

In addition, the features in different embodiments of the present disclosure can be mixed to form another embodiment.

Technical approaches to resolving the tendency of pulverization of silicon particles for the fabrication of anode of LIBs include structural optimization and selection of new materials with higher physical integrity. The new anode material should be less easy to break apart during the reactions to form Li-alloys (expansion in volume) and during decomposition of the Li-alloy (contraction) for releasing Li.

Smaller silicon particles on the order of low tens of nanometers in diameter are expected and have been shown to be less easy to pulverize. The smaller a silicon particle is, the less easy for the particle to break apart during volume changes. Alloys formed by reactions between Li and silicon on the surfaces do not cause as much volume expansion as alloys formed by Li with silicon in the bulk of the silicon particle. The smaller a particle is, the higher the fraction of surface atoms is there. This is especially true when empty space is reserved in the anode for the expansion of silicon particles.

Therefore, deep sub-100 nm silicon particles are favorable as silicon anode for LIB. However, the smaller the silicon particles are, the higher their costs are, too, because extra processing is needed to bring the size down to deep sub-100 nm in sizes. For real-world battery applications, tons of anode materials are needed. Unless economic means of forming deep sub-100 nm sized silicon nanoparticles are developed and the costs become acceptable, the adoption of very small silicon particles as anode materials is not economically acceptable.

In order to reserve room for the volume expansion of silicon particles, a silicon core in a hollow non-silicon shell was proposed and demonstrated to survive volume changes during cycling. Porous silicon presents a similar benefit and has also been reported. Nanostructured silicon structures such as nanowires or nanorods have also been fabricated by either semiconductor top-down etching processes or chemical bottom-up growth of nanoscale silicon structures. These approaches all depend on the invention of affordable mass production processes to make them economic for practical battery uses. At this stage of technology development, they are not accepted for practical uses by the battery market.

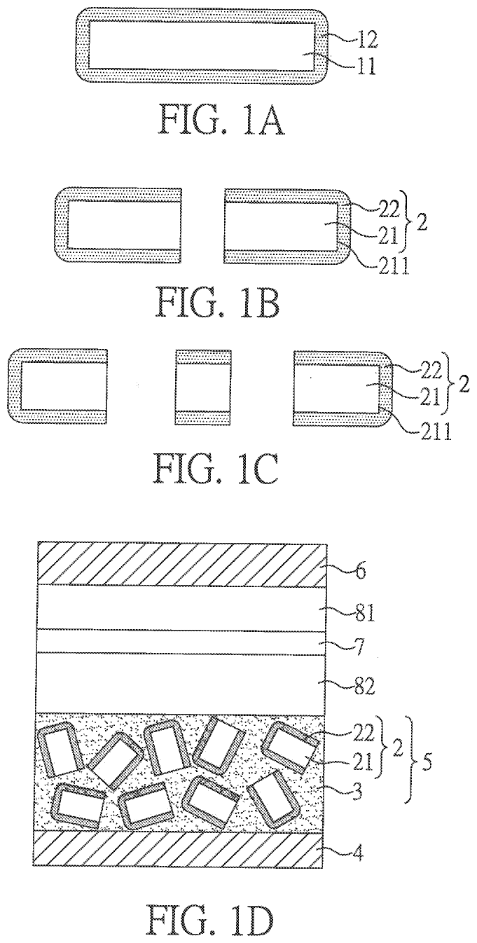

FIG. 1A is a cross-sectional view of a mother core with a mother oxidized layer formed thereon in one embodiment of the present disclosure. As shown in FIG. 1A, a silicon particle as a mother core 11 is provided, and then thermally oxidized to form a mechanically strong and chemically stable silicon dioxide capsule as a mother oxidized layer 12 which encloses the silicon particle (the mother core 11). The silicon dioxide capsule (the mother oxidized layer 12) is formed by the thermal oxidation of the outer layer of the silicon particle (the mother core 11) to form mechanically strong and electrochemically stable silicon dioxide (the mother oxidized layer 12) which encapsulates the silicon particle (the mother core 11) in all direction.

Next, a portion of the encapsulating silicon dioxide is removed to expose the silicon core for reaction with lithium for charging and discharging. One simple and economic way of partially exposing the silicon core to the electrolyte is to break the silicon dioxide encapsulated silicon in to two or more pieces by mechanical ball milling.

Thus, as shown in FIG. 1B and FIG. 1C, the silicon particle (the mother core 11) with the silicon dioxide capsule (the mother oxidized layer 12) formed thereon is broken into two (as shown in FIG. 1B) or three (as shown in FIG. 1C) pieces resulting in a portion of the silicon surfaces not being covered by silicon dioxide. In FIG. 1B and FIG. 1C, only two or three pieces are shown. However, the present disclosure is not limited thereto, multiple pieces may be obtained.

After the aforesaid process, a composite electrode material 2 of the present embodiment is obtained, which comprise: a core 21, wherein the material of the core 21 comprises Si; and an oxidized layer 22 encapsulating a portion of a surface 211 of the core 21, wherein the material of the oxidized layer 22 is silicon oxide.

Mechanical impact by ball milling is effective in breaking silicon dioxide encapsulated silicon particles into multiple smaller pieces. For example, when a silicon dioxide encapsulated silicon particle is broken into two pieces, the silicon dioxide is also broken into two pieces. Each piece of silicon particle will thus expose its broken surface which is no longer encapsulated by the broken capsule made of silicon dioxide. Permeation of lithium through silicon dioxide is poor. However, once a portion of the partially encapsulated silicon particle surface is not covered by silicon dioxide, lithium can diffuse into silicon and react with silicon to form lithium silicon compounds. The compounds can also dissociate to restore silicon. During lithiation, the exposed silicon surface will be lithiated first and then the silicon inside the capsule. The nanocarbon coating provides spare room for volume expansion of silicon.

The broken pieces of silicon dioxide partially encapsulated silicon flakes (i.e. the composite electrode material 2 shown in FIG. 1B or FIG. 1C) are used to fabricate a composite electrode and a Li-based battery comprising the same of the present disclosure.

FIG. 1D is a cross-sectional view of a Li-based battery in one embodiment of the present disclosure. As shown in FIG. 1D, the composite electrode of the present embodiment comprises: a substrate 4; and an active material layer 5 disposed on the substrate 4 and comprising the composite electrode material 2 and an adhesive 3. In the present embodiment, the substrate 4 is a copper foil, and the material of the adhesive 3 is NaCMC; but the present disclosure is not limited thereto. Then, the obtained composite electrode is assembled to form a Li-based battery. As shown in FIG. 1D, the Li-based battery of the present embodiment comprises: the composite electrode as mentioned above; a counter electrode 6 opposite to the composite electrode; a separator 7 disposed between the composite electrode and the counter electrode 6; and an electrolyte layer 81, 82 disposed between the composite electrode and the separator 7 and also disposed between the counter electrode 6 and the separator 7. In the present embodiment, the counter electrode 6 is a Li counter electrode, the separator 7 is a porous membrane (Celgard 2355), and the electrolyte layer 81, 82 comprises 1M LiPF₆ solution dissolved in EC/DEC (1:1 v/v); but the present disclosure is not limited thereto.

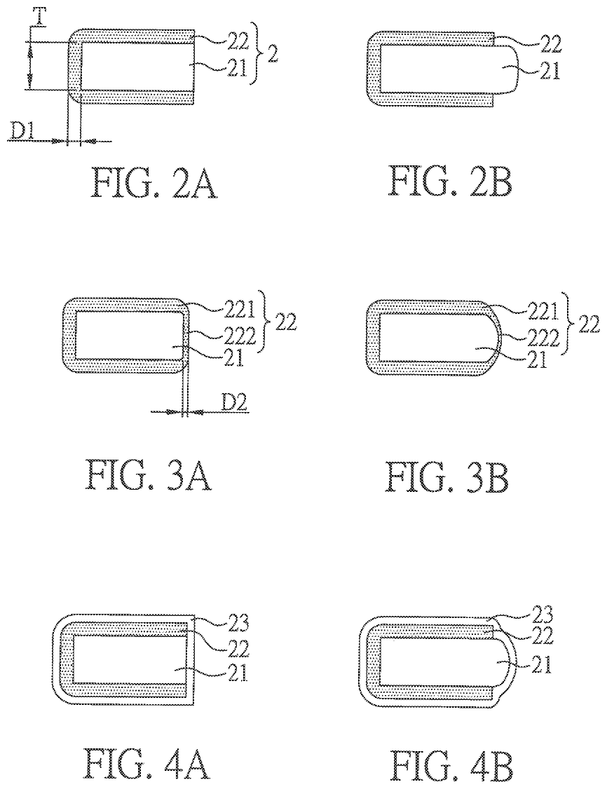

FIG. 2A and FIG. 2B are respectively cross-sectional views of a composite electrode material before and after expanding in one embodiment of the present disclosure.

As shown in FIG. 2A, the silicon flake (the core 21) in a silicon dioxide capsule (the oxidized layer 22) with silicon exposing its surface at one end. As shown in FIG. 2B, the reaction of silicon with lithium to form silicon-lithium compounds while the volume increase of silicon causes the silicon to expand out of the silicon dioxide capsule (the oxidized layer 22). Because the hardness of silicon dioxide, the volume of the silicon dioxide capsule (the oxidized layer 22) increases only a little, but the silicon expands out of the open end of the silicon dioxide capsule (the oxidized layer 22). When the silicon-lithium compound dissociates, the silicon shrinks and restores to the same shape as what is shown in FIG. 2A.

The partially encapsulated silicon particle (the composite electrode material 2) can store and release electrical charges effectively while the silicon dioxide capsule (the oxidized layer 22) holds silicon particle (the core 21) and preventing it from pulverizing and become a loosely packed silicon cluster with high internal resistance. When the silicon particle (the core 21) expands in volume, the silicon dioxide capsule (the oxidized layer 22) confines the silicon particle (the core 21) inside the capsule (the oxidized layer 22) and prevents the silicon particle (the core 21) from breaking apart and becoming loosely and poorly electrically conductive silicon particle. Silicon may expand only from surfaces which are not encapsulated by silicon dioxide capsule (the oxidized layer 22). If some portion of the silicon dioxide capsule (the oxidized layer 22) is broken due to the expansion in volume of the silicon particle (the core 21), the cracks in the silicon dioxide capsule (the oxidized layer 22) provide additional route for lithium to enter and exit the silicon dioxide capsule (the oxidized layer 22) from the charge storage silicon inside the capsule (the oxidized layer 22).

In the present embodiment, the thickness T of the core 21 is 50 nm, and the thickness D1 of the oxidized layer 22 is 25 nm; but the present disclosure is not limited thereto.

FIG. 3A and FIG. 3B are respectively cross-sectional views of a composite electrode material before and after expanding in another embodiment of the present disclosure.

In the present embodiment, the partially encapsulated silicon particle (the composite electrode material 2 shown in FIG. 2A) can be subjected to further oxidation briefly to form a thin silicon oxide (the thin oxidized layer 222) on the broken silicon surface. Thus, the composite electrode material of the present embodiment comprises: the silicon particle (the core 21), and the silicon dioxide capsule (the oxidized layer 22) encapsulating the whole surface of the silicon particle (the core 21), wherein the oxidized layer 22 comprises the thick oxidized layer 221 and the thin oxidized layer 222 integrated with the thick oxidized layer 221. Herein, the thin silicon dioxide (the thin oxidized layer 222) protects the silicon surface while being flexible and capable of expanding outwards along with the silicon. In addition, the thin silicon oxide (the thin oxidized layer 222) allows lithium to permeate through it while providing additional protection of the enclosed silicon particle from breaking apart.

In the present embodiment, the thickness D2 of the thin oxidized layer 222 is 1 nm; but the present disclosure is not limited thereto.

In addition, silicon carbide can also be formed on the exposed silicon surface to confine the silicon particle. Lithium can permeate silicon carbide much more easily than silicon dioxide.

FIG. 4A and FIG. 4B are respectively cross-sectional views of a composite electrode material before and after expanding in another embodiment of the present disclosure.

In the present embodiment, the whole broken silicon dioxide partially encapsulated silicon flake, i.e. the exposed silicon surface of the core 21 and the silicon dioxide capsule (the oxidized layer 22), are coated by a graphitic nanocarbon layer 23, which comprises conductive nanocarbons such as graphene nanowalls, carbon nanotubes, carbon fibers, graphitic particles, a graphitic film or a combination thereof. Alternatively, the conductive nanocarbons can also be synthesized first and then mixed with the silicon dioxide partially encapsulated silicon (including the core 21 and the oxidized layer 22) to form the graphitic nanocarbon layer 23.

Herein, the nanocarbon coating (the graphitic nanocarbon layer 23) provides low serial resistance among silicon dioxide encapsulated silicon particles (including the core 21 and the oxidized layer 22) while allow lithium to enter and exit the silicon particle (the core 21). In addition, the nanocarbon coating (the graphitic nanocarbon layer 23) expands along with the silicon (the core 21), enhances the electrical conductance among silicon dioxide partially encapsulated silicon flakes (including the core 21 and the oxidized layer 22) and reduces electrochemical reactions with the electrolyte.

In the present disclosure, the particle sizes and shapes are not limited. However, it is better to have silicon flakes of about 100 nm in thickness and about 500-1200 nm in width and length. When a layer of 25 nm thick silicon on all sides of a 100 nm thick silicon flake is consumed for oxidation into silicon dioxide, the remaining silicon core is only 50 nm. The 50 nm thick silicon is much more difficult to break into even smaller pieces than the original 100 nm thick silicon. When a silicon flake which is fully encapsulated by silicon dioxide is broken by means of ball milling into two or three pieces, the exposed silicon surfaces are of a width less than the thickness of the silicon flake, for example, sub-100 nm, and of a length approximately equal to the lateral dimension of the silicon flake, for example 200-1200 nm. The exposed surfaces are a small portion of the total surface area of such a silicon flake. When the silicon flake expands in volume, the silicon dioxide will help exhibit better physical integrity. An improved cycling life and capacity retention is thus achieved.

Hereinafter, silicon flakes partially encapsulated by silicon dioxide formed by thermal oxidation of the outer layer of the silicon flakes have been experimentally demonstrated to exhibit excellent capacity and cycling lifetime in comparison with pristine silicon flakes.

### Example 1

Silicon flakes of 100 nm thick and 600-1200 nm wide and long are placed inside a quartz tubing reactor in a high-temperature furnace. Argon gas is fed into the reactor after flowing through a bubbler half filled with water at room temperature. Water vapor is carried by argon gas into the reactor which is heated to 900° C. in water vapor atmosphere. After having been oxidized in water vapor at 900° C. for four hours, silicon flakes are removed from the reactor. The total weight of silicon flakes increases by 46% after part of silicon is oxidized to form SiO₂. The width and length of the silicon flakes are much larger than the thickness. The estimation of the percentage of silicon having been oxidized can be based on the assumption of a silicon flake of infinite lateral size and calculated by the following equation (I).

14×(1−Y)+(14+16×2)×Y=14×(1+X) (I)

Where 14 is the atomic weight of silicon, Y is the percentage of total silicon atoms having been oxidized to form SiO₂, 16 is the atomic weight of oxygen, and X is the increase percentage of the original weight of silicon.

Herein, the increase of the original weight of silicon is 46%, so X is 0.46. After calculating by the equation (I), Y is equal to 0.2, i.e., each surface of a silicon flake has about 10% of the total silicon atoms of the flake having been oxidized into SiO₂, which is so hard and mechanically strong that it can protect silicon from breaking into smaller pieces due to volume expansion and shrinkage during charge-discharge cycling. The oxygen causes the weight to increase indicating that the silicon flakes are fully encapsulated by silicon dioxide.

### Example 2

The silicon flakes are oxidized under the same conditions held in Example 2 for eight hours. The result indicates that the total weight increases by 64%. That is equal to 28% of silicon atoms having been oxidized to form SiO₂. In this case, on each large surface of a silicon flake, 14% of the total silicon atoms are converted to SiO₂. Since SiO₂ has practically no charge storage capacity, the theoretical charge storage capacity of silicon flake decreases by 28%. In return, the strong silicon dioxide surrounding silicon supports the physical integrity of silicon and reduces the chance for it to break and become separated or loosely connected smaller silicon powder. Separated and loosely connected silicon powder has high internal series resistance which is detrimental to the capacity retention and charge-discharge cycling performance of the lithium ion battery.

### Comparative Example 1

Silicon flakes of 100 nm thick and 600-1200 nm wide and long are used as an anode material in the present comparative example. The Li-ion battery half-cell used in the present comparative example has the structure shown in FIG. 1D except that the material layer comprises the silicon flakes without encapsulation by silicon oxide, wherein the substrate 4 is a copper foil, the material of the adhesive 3 is NaCMC, the counter electrode 6 is a lithium metal plate, the separator 7 is a porous membrane (Celgard 2355), and the electrolyte layer 81, 82 comprises 1M LiPF₆ solution dissolved in EC/DEC (1:1 v/v).

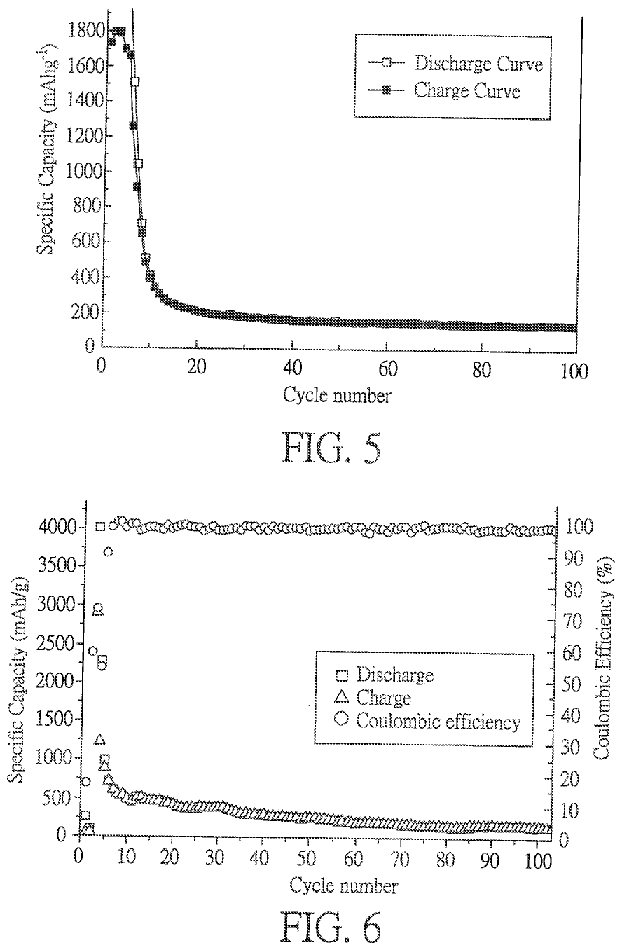

Charge-discharge cycling tests are conducted. In the initial three cycles, charge/discharge rate was 0.02 C, and then changed to 0.1 C for the remaining test. The experimental result is shown in FIG. 5, which indicates the specific capacity falls rapidly down to less than 200 mAh/g due to rapid pulverization of silicon flakes.

### Comparative Example 2

The silicon dioxide encapsulating silicon flakes prepared in Example 1 that the silicon flakes are fully encapsulated by silicon dioxide are used as an anode material in the present comparative example. The Li-ion battery half-cell used in the present comparative example and the charge-discharge cycling tests conducted in the present comparative example are similar to those described in Comparative example 1, except that the anode material of the present comparative example is the silicon dioxide encapsulating silicon flakes prepared in Example 1. In addition, conductive carbon, Super P is used to enhance the electrical conductivity of the silicon dioxide encapsulating silicon flakes.

The experimental result is shown in FIG. 6, which indicates the specific capacity falls rapidly down to about 200 mAh/g. The specific capacity decays rapidly to small capacity value because the permeation of lithium through silicon dioxide to react with silicon is poor and the exposed silicon dioxide has little contribution to the charge storage capacity.

### Example 3

In order to expose silicon which is encapsulated by silicon dioxide, the oxidized silicon flakes prepared in Example 1 that the silicon flakes are fully encapsulated by silicon dioxide are ball milled to break into smaller pieces of 100-300 nm in width and length. Thus, the obtained composite electrode material of the present example has the structure shown in FIG. 1B or FIG. 1C. These smaller silicon flakes have some of their surfaces along the breaking lines caused by ball milling not being covered by silicon dioxide. Lithium can thus react with exposed silicon and diffuse inwards to react with additional silicon atoms inside the broken silicon dioxide capsule.

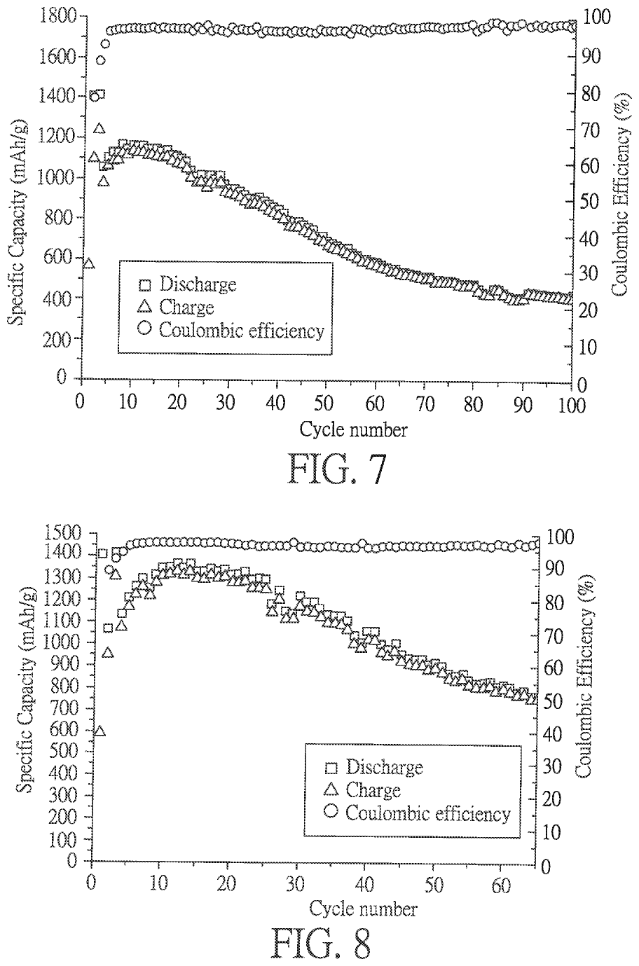

The Li-ion battery half-cell used in the present example and the charge-discharge cycling tests conducted in the present example are similar to those shown in Comparative example 1, except that the anode material used herein is the composite electrode materials mentioned above. The experimental result is shown in FIG. 7, which indicates the specific capacity falls at a lower rate than what is shown in FIG. 6 to about 400 mAh/g. Lithium ions can react with silicon and diffuse into silicon flake from the broken surfaces of the silicon dioxide. Thus, the silicon flakes with surfaces along the breaking lines not being blocked by silicon dioxide reacts with lithium and exhibits higher specific charge storage capacity and an improved retention of the charge storage capacity after charge-discharge cycling.

Please refer to the results shown in Comparative example 2 and Example 3. The permeation of lithium through silicon dioxide is poor and slow. Therefore, silicon flakes which are fully encapsulated by silicon dioxide are expected to exhibit low charge storage capacity. This point has been confirmed in FIG. 6 shown in Comparative example 2.

In order to retain the physical integrity of silicon dioxide encapsulated silicon while allowing lithium to react with silicon to form silicon-lithium compounds during the lithiation process and allowing the compounds to dissociated and restore silicon during the de-lithiation process, a portion of the silicon dioxide which encapsulates a silicon flake needs to be removed to expose silicon without being blocked by silicon dioxide. Among many means of etching silicon dioxide or mechanically removing it, the most economic method is to break the silicon dioxide encapsulated silicon flake into two or multiple pieces which still have most of the silicon surfaces surrounded and supported by silicon dioxide.

The breakage of silicon dioxide encapsulated silicon flake can be achieved economically by ball milling. By the use of different sizes of hard balls to hit the silicon dioxide encapsulated silicon, the silicon dioxide encapsulated silicon flakes can be expected to break into a known range of sizes depending on the sizes of hard balls being used.

Once a silicon dioxide encapsulating silicon flake is broken to become multiple pieces, silicon flakes along the breaking lines will not be covered by silicon dioxide anymore. The breaking lines thus serve as reaction window between silicon and lithium to form compounds and for the compounds to dissociate for releasing lithium. The poor permeation of lithium through silicon dioxide and the effective charging and discharging of silicon flakes having been intentionally broken into multiple pieces are demonstrated in Example 3. The intentionally broken silicon dioxide encapsulating silicon flakes exhibit much better capacity and capacity retention as well as charge-discharge cycling performance.

### Example 4

Silicon dioxide is an electrical insulator. Exposed silicon surfaces are also of high resistance, which limits the charging and discharging current level. Mixing Super P or carbon blacks with these silicon flakes partially encapsulated by silicon dioxide helps reduce the internal series resistance. In order to further reduce the series resistance and to provide multiple electrical conduction paths and buffer space for the volume expansion and shrinkage of the silicon flake, carbon nanotube and other conductive nanocarbon phases are grown on the surface of exposed silicon flakes. The CNT and conductive nanocarbon can also grow on the surfaces of silicon dioxide.

In the present example, the composite electrode material of Example 3 is further coated with electrically conductive nanocarbon including carbon nanotubes and carbon fibers. The process for growing conductive nanocarbon on the surfaces of silicon dioxide and the surface of exposed silicon flakes are shown below.

Thermal CVD of conductive nanocarbon was carried out at 700° C. in vapor mixtures of ferrocene and camphor at the weight ratio of 0.9 g to 2 g with 400 sccm Ar carrying gas. Argon gas bubbles through a water bubbler at room temperature to carry water vapor into the thermal CVD reaction zone. The Thermal CVD process lasted for 6 minutes. The weight ratio of the nanocarbon coating to the silicon and its partial encapsulation is 10%.

The Li-ion battery half-cell used in the present example and the charge-discharge cycling tests conducted in the present example are similar to those shown in Comparative example 1, except that the anode material used herein is the composite electrode materials mentioned above. The experimental result is shown in FIG. 8, which indicates the specific capacity retention is the best with the capacity decays to 700-800 mAh/g after 60 charge-discharge cycles. Nanocarbon maintains electrical conductivity among silicon flakes partially encapsulated by silicon dioxide.

The enhancement of electrical conductivity and provision of multiple electrical conductivity paths by the graphitic nanocarbon further improve the specific capacity and its capacity retention after charge-discharge cycling. This improved performance is obvious when FIG. 8 is compared with FIG. 5 and FIG. 6, which show the poor cycling performance of silicon flakes encapsulated by silicon dioxide and silicon flakes alone, respectively. Anode made of silicon flakes alone without partial silicon dioxide encapsulation nor coating with graphitic nanocarbon pulverize rapidly due to the volume expansion and shrinkage of silicon leading the cell to lose its capacity rapidly and finally fail prematurely.

Thermal oxidation of silicon in water vapor is an economic process and suitable for mass production. Silicon flakes can also be mass produced. Therefore, the present disclosure provides an economic method of producing high-performance silicon-based anode materials for lithium ion battery.

Partially oxidized silicon, i.e., SiOₓ, where x is less than 2, is also a candidate material for the anode of lithium ion battery. The higher x is, the harder the SiOₓ is for retain the physical integrity of the anode. However, the higher hardness is achieved at the cost of lower capacity with increasing x. Besides, the cost for the production of SiOₓ, where x is less than 2, is high. Very high temperature needs to be applied to vaporize silicon and silicon dioxide followed by the condensation of the vapor mixture into non-fully oxidized SiOₓ particles. On the contrary, in the present disclosure, silicon flakes costing about US$10/Kg can be oxidized in a large quantity in an environment of water vapor and then breaking into smaller pieces by commonly applied ball milling method to produce silicon flakes which are only partially encapsulated by silicon dioxide. Further coating of the partially encapsulated silicon flakes with nanocarbons such as carbon nanotubes, graphene, and graphitic carbon films can be done by existing technology.

Although partially oxidized silicon, i.e., SiOₓ, where x is less than 2, is expensive but performing better than pristine silicon, the method of the present disclosure can also further improve its performance by further oxidizing SiOₓ to form an encapsulating silicon dioxide around SiOₓ followed by ball milling to break SiO₂ and expose SiOₓ. By this method, an even stronger anode material with a higher capacity retention ratio can be achieved using SiOₓ partially encapsulated by SiO₂ as the anode materials. Silicon dioxide is stable in the electrolyte and is therefore beneficial to the retention of the capacity of lithium ion battery.

Although the present disclosure has been explained in relation to its embodiment, it is to be understood that many other possible modifications and variations can be made without departing from the spirit and scope of the disclosure as hereinafter claimed.

What is claimed is:

1. A composite electrode material, comprising:
a core, wherein a material of the core is at least one selected from the group consisting of Si, Ge, and a partially oxidized compound thereof; and
an oxidized layer encapsulating at least a portion of a surface of the core, wherein a material of the oxidized layer is a fully oxidized compound of Si, a fully oxidized compound of Ge or a combination thereof,
wherein the material in a portion of the core reacts with lithium ions for lithiation and de-lithiation.

2. The composite electrode material of claim 1, further comprising a graphitic nanocarbon layer, wherein the graphitic nanocarbon layer is formed on the oxidized layer.

3. The composite electrode material of claim 1, further comprising a graphitic nanocarbon layer, wherein the graphitic nanocarbon layer is formed on the oxidized layer and on the surface of the core exposed from the oxidized layer.

4. The composite electrode material of claim 2, wherein the graphitic nanocarbon layer comprises graphene nanowalls, carbon nanotubes, carbon fibers, graphitic particles, a graphitic film or a combination thereof.

5. The composite electrode material of claim 1, wherein the core is a flake particle.

6. The composite electrode material of claim 1, wherein a thickness of the core is in a range from 50 nm to 500 nm.

7. The composite electrode material of claim 1, wherein a length or a width of the core is in a range from 50 nm to 9 μm.

8. The composite electrode material of claim 1, wherein the material of the core is Si.

9. A method for manufacturing a composite electrode material, comprising the following steps:
providing a mother core, wherein a material of the mother core is at least one selected from the group consisting of Si and Ge;
oxidizing the mother core to form a mother oxidized layer on a surface of the mother core, wherein a material of the mother oxidized layer is a fully oxidized compound of Si, a fully oxidized compound of Ge or a combination thereof; and
breaking the mother core with the mother oxidized layer formed thereon to obtain a composite electrode material, which comprises: a core derived from the mother core; and an oxidized layer derived from the mother oxidized layer, wherein the oxidized layer partially exposes the core, and a material of the core exposed from the oxidized layer reacts with lithium ions for lithiation and de-lithiation.

10. The method of claim 9, further comprising a step of forming a graphitic nanocarbon layer on the oxidized layer after the step of breaking the mother core with the mother oxidized layer formed thereon.

11. The method of claim 9, further comprising a step of forming a graphitic nanocarbon layer on the oxidized layer and the core exposed from the oxidized layer after the step of breaking the mother core with the mother oxidized layer formed thereon.

12. The method of claim 10, wherein the graphitic nanocarbon layer comprises graphene nanowalls, carbon nanotubes, carbon fibers, graphitic particles, a graphitic film or a combination thereof.

13. The method of claim 9, wherein the core is a flake particle.

14. The method of claim 9, wherein a thickness of the core is in a range from 50 nm to 500 nm.

15. The method of claim 9, wherein a length or a width of the core is in a range from 50 nm to 9 μm.

16. The method of claim 9, wherein the material of the mother core is Si.

17. A composite electrode, comprising:
a substrate; and
an active material layer disposed on the substrate and comprising a composite electrode material, wherein the composite electrode material comprises:
a core, wherein a material of the core is at least one selected from the group consisting of Si, Ge, and a partially oxidized compound thereof; and
an oxidized layer encapsulating at least a portion of a surface of the core, wherein a material of the oxidized layer is a fully oxidized compound of Si, a fully oxidized compound of Ge or a combination thereof,
wherein the material in a portion of the core reacts with lithium ions for lithiation and de-lithiation.

18. A lithium-based battery, comprising:
a composite electrode;
a counter electrode opposite to the composite electrode;
a separator disposed between the composite electrode and the counter electrode; and
an electrolyte layer disposed between the composite electrode and the separator and also disposed between the counter electrode and the separator,
wherein the composite electrode comprises:
a substrate; and
an active material layer disposed on the substrate and comprising a composite electrode material, wherein the composite electrode material comprises:
a core, wherein a material of the core is at least one selected from the group consisting of Si, Ge, and a partially oxidized compound thereof; and
an oxidized layer encapsulating at least a portion of a surface of the core, wherein a material of the oxidized layer is a fully oxidized compound of Si, a fully oxidized compound of Ge or a combination thereof,
wherein the material in a portion of the core reacts with lithium ions for lithiation and de-lithiation.
